(19) United States
(12) Patent Application Publication
(10) Pub. No.: US 2020/0361548 A1
(43) Pub. Date: Nov. 19, 2020

(54) CRAWLER TRACK FOR TRACKED VEHICLES

(71) Applicant: KOMATSU GERMANY GMBH, 40597 Düsseldorf (DE)

(72) Inventors: HENRY SCHWARZ, Monheim (DE); JENS JUNGHANS, RATINGEN (DE); MATTHIAS RÖSCH, Düsseldorf (DE); SEBASTIAN SPELDRICH, Düsseldorf (DE)

(73) Assignee: KOMATSU GERMANY GMBH, 40597 Düsseldorf (DE)

(21) Appl. No.: 16/637,146

(22) PCT Filed: May 9, 2018
(86) PCT No.: PCT/EP2018/062003

§ 371 Date: Feb. 6, 2020

(30) Foreign Application Priority Data
Aug. 7, 2017 (DE) 10 2017 117 838.4

(51) Int. Cl. B62D 55/21; B62D 55/15

(52) U.S. Cl. CPC B62D 55/21; B62D 55/26; B62D 55/15

(57) ABSTRACT

The invention relates to a crawler track for tracked vehicles, wherein the chain links are provided with articulated eyes facing one another, in which chain bolts connecting the chain links to one another are arranged. At the respective outer contour of the areas of the articulated eyes facing one another, a contour adaptation takes places on at least a partial circumference of the articulated eye, which on at least a partial area has a curvature, which is zero or positive (convex) in the viewing direction from the adjoining articulated eye end face to the center of the articulated eye.

The invention relates to a crawler track, comprised of one-piece cast chain links, for tracked vehicles, in which the chain links have articulated eyes which face one another and in which the chain links are connected to one another by chain bolts.

The bolt connection is designed as a clearance fit. In the event of wear, all chain links have to be replaced.

Practice has repeatedly shown the presence of excessive wear on the chassis components, in particular on the chain.

There was therefore a desire to improve the wear behavior at the jointed points. Bushings and/or lubricant are used and pressed into previous clearance fits of bolt connections of chain links to optimize wear. The pressed-in bushings are mainly used to minimize material costs upon replacement in the event of wear. Lubricant should reduce the friction on one hand, and transport the wear particles out of the bearing point on the other hand. However, both solutions have the disadvantage of incurring added costs and involve additional assembly effort.

Previous articulated eyes with clearance fit have a straight outer contour that is constant over the width of the articulated eyes. The ends oftentimes have a radius for casting reasons or to ensure better mechanical installation. Theory suggests that pressure greatly increases towards the edges of the articulated eye, when the joint is stressed, causing high wear there.

According to the invention, the posed object is achieved with a crawler track for tracked vehicles, in which the chain links have articulated eyes which face one another and in which the chain links are connected to one another by chain bolts, in such a way as to provide a contour adaptation to the respective outer contour of the mutually facing regions of the articulated eyes at least on a partial circumference of the articulated eye, which contour adaptation has at least on a partial region a curvature which is zero or positive (convex) in viewing direction from the adjacent articulated eye end face to the center of the articulated eye. This type of material removal at the edges results in a less rigid component behavior, causing lower pressures in these regions. The only exception is a single radius, which is necessary for casting or assembly reasons.

EP 0 672 004 B1 also mentions a contour adjustment of the articulated eye, however for a press fit by which the frictional transmission of longitudinal forces and torques should be made possible without additional safeguard against displacement and twisting.

According to a configuration of the invention, the outer contour of the articulated eyes follows a continuous or discontinuous mathematical function.

The outer contour of the articulated eyes may also be implemented by one or more mathematical elements such as, e.g., straight lines, radii, polynomial functions, exponential functions, power functions, logarithmic functions, or trigonometric functions.

According to a further variant, the outer contour of the articulated eyes can be established of free-form curves or splines (nth-degree splines (also polynomial train), which are a function that is pieced together from polynomials of at most nth degree.).

The outer contour of the articulated eyes on the chain link is thus configured in such a way that a better stress distribution with reduced edge pressure between bolt and articulated eye is realized when under stress.

The choice of the curve depends on the desired, resulting pressure profile or wear behavior that should be achieved.

The invention will be explained in greater detail with reference to the drawings.

It is shown in:

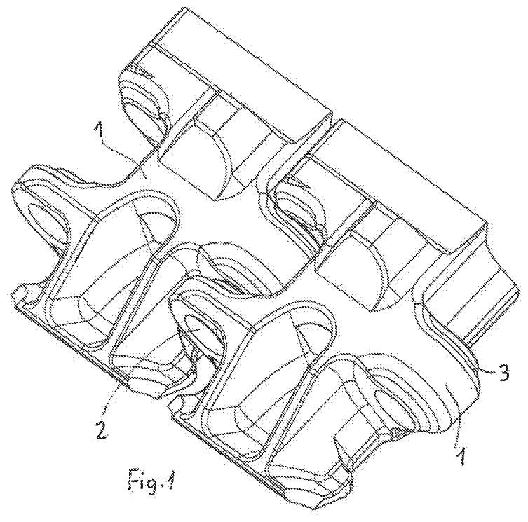

FIG. 1 a perspective view of a part of the crawler track with two chain links (halves);

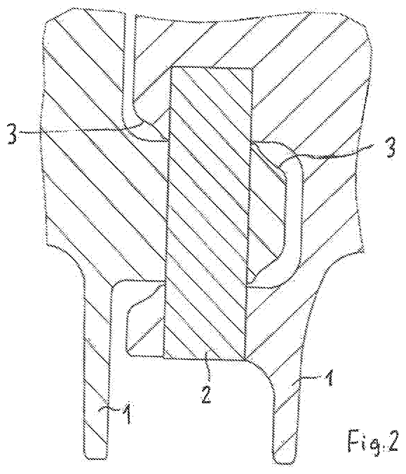

FIG. 2 a section through the middle of the chain link;

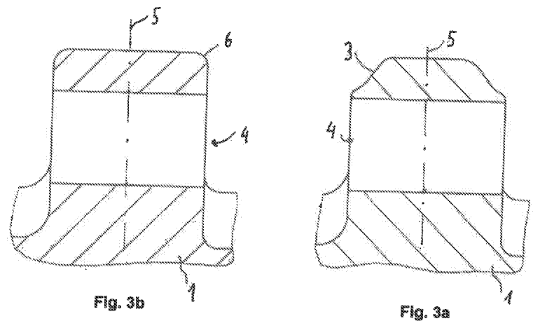

FIG. 3 comparison of articulated eyes.

The chain link, depicted in FIG. 1, is comprised in the simplest case of chain links 1, which are connected by chain bolts 2 via a clearance fit. Further variants with pressed-in bushings or lubricants are possible.

Starting from the articulated eye end face 4, the outer contour 3 of the articulated eyes on the chain link is adjusted such as to establish a better stress distribution with reduced edge pressure between bolt and articulated eye under stress.

This is achieved according to the invention in that a contour adjustment is implemented on the outer contour of the mutually facing regions of the articulated eyes at least on a partial circumference of the articulated eye (FIG. 2).

As mentioned above, previous articulated eyes with clearance fit have a straight outer contour which is constant over the width of the articulated eye and which transitions into the end faces 4 of the link with a cast radius 6. (FIG. 3b). When viewing the articulated eyes in accordance with the invention, depicted next to it (FIG. 3a), the difference becomes obvious because the respective outer contours of the optimized articulated eyes now have on at least one partial region a curvature, which is zero or positive (convex) in viewing direction from the adjacent articular eye end face 4 to the center 5 of the articulated eye.

What is claimed is:

1.-5. (canceled)

6. A crawler track for a tracked vehicle, said crawler track comprising:
chain links having articulated eyes which face one another; and
chain bolts received in the articulated eyes to connect the chain links,
wherein a contour adjustment is implemented on an outer contour of regions of facing ones of the articulated eyes at least on a partial circumference of the articulated eye and has at least on a partial area a curvature which is zero or positive (convex) in a viewing direction from an adjacent articulated eye end face to a center of the articulated eye.

7. The crawler track of claim 6, wherein the outer contour of the articulated eyes follows a continuous or discontinuous mathematical function.

8. The crawler track of claim 6, wherein the outer contour of the articulated eyes is made from at least one mathematical element selected from the group consisting of straight line, radius, polynomial function, exponential function, power function, logarithmic function, and trigonometric function.

9. The crawler track of claim 6, wherein the outer contour of the articulated eyes is made of free-form curves or splines.

10. The crawler track of claim 6, further comprising at least one of a bushing and a lubricant.
